(19) United States
(12) Patent Application Publication
(10) Pub. No.: US 2009/0072427 A1
(43) Pub. Date: Mar. 19, 2009

(54) PROCESS FOR VARYING THE APPEARANCE OF A CONTAINER HAVING A FOAMED WALL

(76) Inventors: Frank E. Semersky, Holland, OH (US); William D. Voyles, Toledo, OH (US)

Correspondence Address: FRASER CLEMENS MARTIN & MILLER LLC, 28366 KENSINGTON LANE, PERRYSBURG, OH, 43551, US

(21) Appl. No.: 12/276,687

(22) Filed: Nov. 24, 2008

Related U.S. Application Data
(63) Continuation-in-part of application No. 11/384,979, filed on Mar. 20, 2006.
Application No. 11/384,979 is a continuation-in-part of application No. PCT/US07/06264, filed on Mar. 12, 2007.

(51) Int. Cl. B29C 44/02

(52) U.S. Cl. 264/50

(57) ABSTRACT

A process for varying the appearance of a container is disclosed, the process comprises injection molding a polymer preform having a non-reactive gas entrapped within the walls thereof, cooling the preform to a temperature below the polymer softening temperature, reheating the preform to a predetermined temperature greater than the polymer softening temperature, and blow molding the reheated preform, to prepare a container consisting essentially of a micro cellular foamed polymer having a non-reactive gas contained within the micro cellular foam cells, wherein the appearance of the container is varied based on the predetermined temperature.

### CROSS-REFERENCE TO RELATED APPLICATION

This application is a continuation-in-par of U.S. patent application Ser. No. 11/384,979 filed on Mar. 20, 2006 hereby incorporated herein by reference in its entirety, and International POT Application No. PCT/US07/06264 filed on Mar. 12, 2007 hereby incorporated herein by reference in its entirety.

### FIELD OF THE INVENTION

The present invention relates generally to a foamed-wall polymer container having a unique appearance. More particularly, the invention is directed to a process for varying the appearance of a container comprising micro cellular foam, wherein the foam micro cells contain a non-reactive gas such as nitrogen, and the container has a silvery appearance.

### BACKGROUND OF THE INVENTION

Biaxially oriented single and multi-layered containers may be manufactured from polymer materials such as, for example, polyethylene terephthalate (PET) using a hot preform process, wherein a single or multi-layered preform is heated to its desired orientation temperature and drawn and blown into conformity with a surrounding mold cavity. The preform may be prepared by any conventional process such as, for example, by extruding a preform comprising single or multiple layers of polymer, or by injecting subsequent layers of polymer over a previously injection molded preform. Generally, multiple layers are used for beverage containers, to add diffusion barrier properties not generally found in single layer containers.

The various layers of polymers in the prior art multi-layered containers are generally in intimate contact with one another, thereby facilitating conduction of thermal energy through the walls of the containers. This allows the chilled contents of the container to quickly warm to the ambient temperature. Accordingly, such containers are often sheathed in, for example, a foamed polystyrene shell to impart thermal insulating properties to the container.

It would be desirable to prepare an improved plastic container which is opaque with unique visual properties without the addition of a coloring agent. Further, it is deemed desirable to impart thermal insulating properties to the improved plastic container. Also, it would be desirable to discover a process for varying the appearance of a container having a foamed wall without requiring the addition of a coloring agent which would adversely affect the recycling characteristics of the container.

### SUMMARY OF THE INVENTION

Accordant with the present invention, a process for varying the appearance of a foamed-wall container having a unique appearance has surprisingly been discovered. The container comprises a micro cellular foamed polymer, and a non-reactive gas contained within the micro cellular foam cells, wherein the container has a silvery appearance without the addition of a coloring agent. The container according to the present invention is particularly useful for packaging carbonated beverages.

According to an embodiment of the invention, the process for varying an appearance of a container, comprises the steps of injection molding a polymer preform having a non-reactive gas entrapped within the walls thereof; cooling the preform to a temperature below the polymer softening temperature; reheating the preform to a predetermined temperature greater than the polymer softening temperature; and blow molding the reheated preform, to prepare a container consisting essentially of a micro cellular foamed polymer having a non-reactive gas contained within the micro cellular foam cells, wherein the appearance of the container is varied based on the predetermined temperature.

According to another embodiment of the invention, the process for varying an appearance of a container, comprises the steps of injection molding a polymer preform having a non-reactive gas entrapped within the walls thereof; cooling the preform to a temperature below the polymer softening temperature; reheating the preform to a predetermined temperature greater than the polymer softening temperature; and blow molding the reheated preform, to prepare a container consisting essentially of a micro cellular foamed polymer having a on-reactive gas contained within the micro cellular foam cells, wherein the translucence of the container is varied based or the predetermined temperature.

According to another embodiment of the invention, the process for varying an appearance of a container, comprises the steps of injection molding a polymer preform having a non-reactive gas entrapped within the walls thereof, cooling the preform to a temperature below the polymer softening temperature; reheating the preform to a predetermined temperature greater than the polymer softening temperature; and blow molding the reheated preform, to prepare a container having a silvery appearance consisting essentially of a micro cellular foamed polymer having a non-reactive gas contained within the micro cellular foam cells, wherein the translucence of the container is varied based on the predetermined temperature.

### DETAILED DESCRIPTION OF THE PREFERRED EMBODIMENT

The following detailed description describes various exemplary embodiments of the invention. The description serves to enable one skilled in the art to make and use the invention, and are not intended to limit the scope of the invention in any manner. In respect of the methods disclosed, the steps presented are exemplary in nature, and thus, the order of the steps is not necessary or critical.

An embodiment of the invention is directed to a process for preparing a container comprising a first layer of plastic and a second layer of plastic contacting the first layer, the second layer of plastic formed as a foam wherein the foam cells contain a fluid such as carbon dioxide and nitrogen, for example.

The first and second layers of plastic may be the same or different, in composition, thickness, orientation, etc. Furthermore, the invention contemplates a container having any number (greater than one) of layers of plastics, as long as at least one of the plastic layers comprises a foam. Moreover, the invention contemplates the use of a cellular foam plastic layer wherein the foam cells contain not only carbon dioxide, but also one or more other gasses.

Suitable polymers from which the container may be prepared include, but are not necessarily limited to, polyethylene terephthalate (PET) and other polyesters, polypropylene, acrylonitrile acid esters, vinyl chlorides, polyolefins, polyamides, and the like, as well as derivatives, blends, and copolymers thereof A suitable polymer for commercial purposes is PET.

Polymer flakes are melted in a conventional plasticizing screw extruder, to prepare a homogeneous stream of hot polymer melt at the extruder discharge. Typically, the temperature of the polymer melt stream discharged from the extruder ranges from about 225 degrees Centigrade to about 325 degrees Centigrade. One ordinarily skilled in the art will appreciate that the temperature of the polymer melt stream is determined by several factors, including the kind of polymer flakes used, the energy supplied to the extruder screw, etc. As an example, PET is conventionally extruded at a temperature from about 260 degrees Centigrade to about 290 degrees Centigrade. A non-reactive gas is injected under pressure into the extruder mixing zone, to ultimately cause the entrapment of the gas as micro cellular voids within the polymer material. The term “non-reactive gas” as it is used herein means a gas that is substantially inert vis-à-vis the polymer. The non-reactive gases may include carbon dioxide, nitrogen, and argon, as well as mixtures of these gases with each other or with other gasses, for example.

According to the present invention, the extrudate is injection molded to form a polymer preform having the non-reactive gas entrapped within the walls thereof. Methods and apparatuses for injection molding a polymer preform are well-known in the art.

It is well-known that the density of amorphous PET is 1.335 grams per cubic centimeter. It is also known that the density of PET in the melt phase is about 1.200 grams per cubic centimeter. Thus, if the preform injection cavity is filled completely with molten PET and allowed to cool, the resulting preform would not exhibit and would have many serious deficiencies, such as sink marks. The prior a injection molding literature teaches that, in order to offset the difference in the densities of amorphous and molten PET, a small amount of polymer material must be added to the part after the cavity has been filled and as the material is cooling. This is called the packing pressure. Thus, about ten percent more material must be added during the packing pressure phase of the injection molding cycle in order to ensure that a preform made by injection molding is filled adequately and fully formed. The packing pressure phase of the injection molding operation is likewise used for polymer materials other than PET.

According to the present invention, however, the polymer preform is injection molded and simultaneously foamed using a non-reactive gas. The gas is entrained in the material during the injection phase. Contrary to the prior art injection molding process, wherein additional polymer material is injected during the packing phase, the present invention utilizes packing pressure less than conventionally used. As the polymer material is still in a molten state, the partial pressure of the non-reactive gas is sufficient to permit the release of the dissolved gas from the polymer into the gas phase, where it forms the micro cellular foam structure. Thus, the preform made by the inventive process weighs less than, but has the same form and geometry as, the polymer preforms produced by the conventional injection molding operations that employ the packing process.

The micro cells may contain one or more of a variety of gases typically used in processes for making micro cellular foam structures. Depending on certain injection and blow molding parameters which control the size of the micro cells, the micro cellular foam tends to act as an effective thermal insulator, to retard the conduct of heat energy from the atmosphere to the chilled carbonated beverage within the container.

Alternatively, the preform may be made by injection molding a plastic material such as, for example, polyethylene terephthalate (PET) using processes and equipment known in the art. The preform is then overmolded with a foamed material to form an overmolded preform. The overmolded preform includes an inner formed from the preform and an outer formed from the foamed material. Suitable as from which the foamed material may be prepared include, but are not necessarily limited to, polyesters, acrylonitrile acid esters, vinyl chlorides, polyolefins, polyamides, and the like, as well as derivatives, blends, and copolymers thereof. A preferred plastic for the foamed material is PET. The foamed material may be coextensively formed with the material forming the preform by a coextrusion process, or the foamed material may be applied to or received by the preform by simultaneously injection molding the foamed material and the material forming the preform. Alternatively, the foamed material may be formed with the preform in a multi-step process such as a multi-step injection molding process. The overmolded preform may be formed in the same mold in which the preform is made by using the multi-step injection molding process, or the preform may be transferred to a second mold for the overmolding step by using an insert molding process. The thickness and surface area of the foamed material overmolded onto the preform will vary based upon design considerations such as cost and a desired appearance of the overmolded container.

Upon completion of the preform, the preform is cooled to a temperature below the polymer softening temperature. For example, the softening temperature for PET is approximately 70 degrees Centigrade. Thus, the entrapped non-reactive gas is retained within the walls of the polymer preform. The cooling step conditions the polymer and preserves its desirable properties for the successful preparation of a blow molded container. The cooling step is also useful when employing polymers such as polyesters, which cannot be blow molded directly from an extruded parison. The cooling step may be effected by any conventional process used in the polymer forming art such as, for example, by passing a stream of a cooling gas over the surfaces of the preform, or cooling the preform while in-mold by cooling the forming mold.

The preform is thereafter reheated to a predetermined temperature above the polymer softening temperature. This heating step may be effected by well-known means such as, for example, by exposure of the preform to a hot gas stream, by flame impingement, by exposure to infra-red energy, by passing the preform through a conventional oven or an oven having infrared heaters, or the like. It is understood that the heating step of the preform may also occur in a heated mold or with a heated fluid in a mold. By heating the preform to a desired and predetermined temperature, the translucence, and therefore appearance, of the container blow molded from the preform may be selectively varied. The translucence of the container may be selectively varied across a range until the container is opaque. At temperatures of about 106 degrees Centigrade, the container has a silvery appearance and is translucent. At temperatures of about 112 degrees Centigrade, the container has a silvery appearance and less translucent than the container formed from the preform heated to 106 degrees Centigrade. At temperatures of about 116 degrees Centigrade, the container has a silvery appearance and is less translucent still and may be opaque. Thus, as the desired temperature for reheating the preform increases, the translucence of the container formed therefrom decreases. The desired temperature may be increased to temperatures above 116 degrees Centigrade, thereby resulting in an opaque container having a silvery appearance or an opaque container having a white appearance. If PET is reheated too far above its glass transition temperature, or held at a temperature above its softening temperature for an excessive period of time, the PET undesirably will begin to crystallize. Likewise, if the preform is heated to a temperature above which the mechanical properties of the material are exceeded by the increasing pressure of the non-reactive gas in the micro cells, the micro cells undesirably will begin to expand thus distorting the preform.

As used herein, the word “translucent” means permitting light to pass through but diffusing it so that objects on an opposite side are not clearly visible. Translucent does not mean transparent. Transparent means having the property of transmitting rays of light through its substance so that bodies situated beyond or behind can be distinctly seen. As used herein, the word “opaque” means not transparent or translucent; impenetrable to light. Therefore in summation, a container that is transparent is not translucent or opaque, a container that is translucent is not transparent or opaque, and a container that is opaque is not translucent or transparent. Further, based on the definitions provided herein, there are no varying degrees of transparency or opacity while translucence may vary.

Finally, the preform is blow molded, to prepare a container, consisting essentially of a micro cellular foamed polymer having a non-reactive gas contained within the micro cellular foam cells and having a desired appearance. Methods and apparatus for blow molding a container from a polymer preform are well-known.

The blow molded foamed-wall polymer container so produced has a silvery appearance; as though the container were made of metal. The blow molded container is silvery in color, and may exhibit Pantone Color Formula Guide numbers in the range of about 420 through 425, 877, 8001, 8400, and 8420. In terms of the CIE L*a*b* Color Scale, the blow molded container is silvery in color, and may exhibit L* values in the range from about 50.5 to about 65.5; a* values in the range from about −0.50 to about −0.01; and b* values in the range from about −4.50 to about −0.1. Using the methods described herein, containers having a favorable silvery color exhibiting L* values in the range from about 56.07 to about 60.02; a* values in the range from about −0.13 to about −0.06; and b* values in the range from about −2.42 to about −2.20. In terms of another color index, the Pantone Color Formula Guide, the color of the container is about Pantone Color Formula Guide number 420, 421, 422, 423, 424, 425, 877, 8001, 8400, or 8420. While not wishing to be bound by any particular theory regarding the reason that the ultimately produced container has a unique silvery appearance, it is believed that, as the preform cavity is being filled with polymer, bubbles of gas are formed at the flow front of the polymer due to the pressure drop between the dissolved gas and the relatively lower pressure in the preform cavity. The bubbles formed at the flow front of the polymer material as it is introduced into the preform cavity are subsequently deposited on the outside and inside surfaces of the prefer.

From the forgoing description, one ordinarily skilled in the art can easily ascertain the essential characteristics of the invention, and without departing from its spirit and scope, can make various changes and modifications to adapt the invention to various uses and conditions.

What is claimed is:

1. A process for varying an appearance of a container, comprising the steps of:
injection molding a polymer preform having a non-reactive gas entrapped within the walls thereof;
cooling the preform to a temperature below the polymer softening temperature;
reheating the preform to a predetermined temperature greater than the polymer softening temperature;
increasing the predetermined temperature to vary the translucence of a container prepared from blow molding the reheated preform; and
blow molding the reheated preform to prepare the container, the container consisting essentially of a micro cellular foamed polymer having a non-reactive gas contained within the micro cellular foam cells.

2. The process for preparing a container according to claim 1, wherein the polymer comprises one or more of a polyester, polypropylene, acrylonitrile acid ester, vinyl chloride, polyolefin, polyamide, or a derivative or copolymer thereof.

3. The process for preparing a container according to claim 1, wherein the polymer comprises polyethylene terephthalate.

4. The process for preparing a container according to claim 1, wherein the non-reactive gas comprises at least one of carbon dioxide, nitrogen, and argon.

5. The process for preparing a container according to claim 1 wherein the non-reactive gas comprises nitrogen.

6. The process for preparing a container according to claim 1, wherein as the predetermined temperature increases, the translucence of the container decreases.

7. The process for preparing a container according to claim 1, wherein the predetermined temperature is from about 106° C. to about 116° C.

8. The process for preparing a container according to claim 7, wherein the container has a silvery appearance with a color of the container having CIE L*a*b* Color Scale values of: L* values in the range from about 55.5 to about 61.5; a* values in the range from about −0.20 to about −0.01; and b* values in the range from about −2.50 to about −2.1.

9. The process for preparing a container according to claim 8, wherein the container has a silvery appearance with a color of the container having CIE L*a*b* Color Scale values of: L* values in the range from about 56.07 to about 60.02; a* values in the range from about −0.13 to about −0.06; and b* values in the range from about −2.42 to about −2.20

10. The process for preparing a container according to claim 7, wherein the color of the container is about Pantone Color Formula Guide number 420, 421, 422, 423, 424, 425, 877, 8001, 8400, or 8420.

11. The process for preparing a container according to claim 10, wherein the color of the container is about Pantone Color Formula Guide number 420, 421, 422, 423, 424, or 425.

12. The process for preparing a container according to claim 1, wherein the preform is reheated with at 1-east one of an infrared heater and a heated fluid.

13. The process for preparing a container according to claim 1, wherein the preform is an overmolded preform including an inner layer and an outer layer having the non-reactive gas entrapped within the walls thereof.

14. A process for varying an appearance of a container, comprising the steps of:
injection molding a polymer preform having a non-reactive gas entrapped within the walls thereof;
cooling the preform to a temperature below the polymer softening temperature;
reheating the preform to a predetermined temperature greater than the polymer softening temperature;
increasing the predetermined temperature to vary the translucence of a container prepared from blow molding the reheated preform, wherein as the predetermined temperature increases, the translucence decreases; and
blow molding the reheated preform to prepare the container, the container consisting essentially of a micro cellular foamed polymer having a non-reactive gas contained within the micro cellular foam cells.

15. The process for preparing a container according to claim 14, wherein the predetermined temperature is from about 106° C. to about 116° C.

16. The process for preparing a container according to claim 14, wherein the container has a silvery appearance with a color of the container having CIE L*a*b* Color Scale values of: L* values in the range from about 55.5 to about 61.5; a* values in the range from about −0.20 to about −0.01, and b* values in the range from about −2.50 to about −2.1.

17. The process for preparing a container according to claim 14, wherein the color of the container is about Pantone Color Formula Guide number 420, 422, 423, 424, 425, 877, 8001, 8400, or 8420.

18. The process for preparing a container according to claim 14, wherein the preform is an overmolded preform including an inner layer and an outer layer having the non-reactive gas entrapped within the walls thereof.

19. A process for varying an appearance of a container, comprising the steps of:
injection molding a polymer preform having a non-reactive gas entrapped within the walls thereof;
cooling the preform to a temperature below the polymer softening temperature;
reheating the preform to a predetermined temperature greater than the polymer softening temperature;
increasing the predetermined temperature to vary the translucence of a container prepared from blow molding the reheated preform; and
blow molding the reheated preform to prepare the container, the container having a silvery appearance and consisting essentially of a micro cellular foamed polymer having a non-reactive gas contained within the micro cellular foam cells.

20. The process for preparing a container according to claim 19, wherein as the predetermined temperature increases, the translucence of the container decreases.
